(19) United States
(12) Patent Application Publication
(10) Pub. No.: US 2026/0289212 A1
(43) Pub. Date: Sep. 24, 2026

(54) System for Communicating Information Using QR Codes, NFC, and Augmented Reality

(71) Applicant: George GRANT, Toronto (CA)

(72) Inventor: George GRANT, Toronto (CA)

(21) Appl. No.: 19/180,365

(22) Filed: Apr. 16, 2025

Related U.S. Application Data
(60) Provisional application No. 63/634,957, filed on Apr. 17, 2024.

(51) Int. Cl. G06K 19/06

(52) U.S. Cl. CPC G06K 19/06037; G06K 19/06103

(57) ABSTRACT

A system including an article having at least one QR code, at least one NFC tag, and at least one printed image; and a device having a camera, an NFC chip, a display screen, and a speaker. The at least one QR code contains displayable information or contains a link to displayable information. The device is configured to read the at least one QR code using the camera, and to display the displayable information using the display screen. The device is configured to read the at least one NFC tag using the NFC chip, and to perform an action based on an NFC signal received from the at least one NFC tag. The device, using the camera, is configured to recognize the at least one printed image. The device is configured to provide an augmented reality output upon recognition of the at least one printed image.

### RELATED APPLICATION

This application claims priority to the 17 Apr. 2024 filing date of U.S. Provisional Patent Application Ser. No. 63/634,957, which is incorporated herein by reference.

### FIELD OF THE INVENTION

This invention relates to communication systems, and more particularly to posters that incorporate QR Codes, NFC tags, and Augmented Reality images.

### BACKGROUND OF THE INVENTION

Information is often communicated in the form of papers or posters, which may incorporate printed images and/or text. Communicating information in this way has a number of advantages, including being relatively low cost, and not requiring a power source.

A disadvantage of traditional printed posters is that the amount of information, and the type of information, that can be displayed is limited.

### SUMMARY OF THE INVENTION

To at least partially overcome some of the disadvantages of previously known systems, articles, devices, and methods, in one aspect the present invention provides a system including an article having at least one QR code, at least one NFC tag, and at least one printed image; and a device having a camera, an NFC chip, a display screen, and a speaker. The at least one QR code contains displayable information or contains a link to displayable information, and the device is configured to read the at least one QR code using the camera, and to display the displayable information using the display screen. The device is configured to read the at least one NFC tag using the NFC chip, and to perform an action based on an NFC signal received from the at least one NFC tag. The device, using the camera, is configured to recognize the at least one printed image, and to provide an augmented reality output upon recognition of the at least one printed image.

The applicant has appreciated that the system in accordance with the invention allows for a variety of different types of information to be displayed and actions to be performed, while retaining the benefits of traditional poster technologies.

For example, the QR codes can provide links to a great deal of information, including electronic documents or web pages, which can provide a quantity of information that far exceeds the amount of information that could be directly printed on a poster. The information can also be provided in formats, such as video or audio, which cannot be printed directly on a poster.

The NFC tags can furthermore be used to cause the device to automatically perform a desired action, such as initiate a telephone call, send an email, participate in a poll, respond to a questionnaire, transmit contact information, make a purchase or payment, or automate an application such as sight or sound. This is not possible using traditional poster technology,

The device is also able to recognize the printed image, and is configured to provide an augmented reality output when the image is recognized. The image may, for example, be a photograph printed on the poster, and the augmented reality output might, for example, be a video that is played over top of the photograph's position when the poster is viewed on the device's display screen.

The system thus allows for a great deal of different types of information to be communicated, as well as enabling a variety of different actions and interactive features. At the same time, the poster itself can be produced at low cost, with the QR codes and printed images being printed directly on the poster using traditional printing techniques. The NFC tags can furthermore be attached to the poster as stickers, for example by affixing the stickers to the back side of the poster behind the QR codes.

The NFC tags are preferably passive tags that do not require their own power source. The posters thus preferably do not require batteries or an electrical connection.

Further aspects of the invention include the following:
1. A system, which optionally incorporates one or more features of any one or more of the preceding and/or following aspects, comprising: an article having at least one QR. code, at least one NFC tag, and at least one printed image; and a device having a camera, an NFC chip, a display screen, and a speaker; wherein the at least one QR code contains displayable information or contains a link to displayable information; wherein the device is configured to read the at least one QR code using the camera, and to display the displayable information using the display screen; wherein the device is configured to read the at least one NFC tag using the NFC chip, and to perform an action based on an NFC signal received from the at least one NFC tag; wherein the device, using the camera, is configured to recognize the at least one printed image; and wherein the device is configured to provide an augmented reality output upon recognition of the at least one printed image.
2. A system, which optionally incorporates one or more features of any one or more of the preceding and/or following aspects, wherein the article comprises a paper,
3. A system, which optionally incorporates one or more features of any one or more of the preceding and/or following aspects, wherein the article comprises a poster,
4. A system, which optionally incorporates one or more features of any one or more of the preceding and/or following aspects, wherein the device comprises a smartphone.
5. A system, which optionally incorporates one or more features of any one or more of the preceding and/or following aspects, wherein the device comprises a tablet computer.
6. A system, which optionally incorporates one or more features of any one or more of the preceding and/or following aspects, wherein the device comprises a smart watch.
7. A system, which optionally incorporates one or more features of any one or more of the preceding and/or following aspects, wherein the at least one QR code comprises a plurality of QR codes.
8. A system, which optionally incorporates one or more features of any one or more of the preceding and/or following aspects, wherein the at least one NFC tag comprises a plurality of NFC tags.
9. A system, which optionally incorporates one or more features of any one or more of the preceding and/or following aspects, wherein the at least one printed image comprises a plurality of printed images.
10. A system, which optionally incorporates one or more features of any one or more of the preceding and/or following aspects, wherein the article further comprises printed text.
11. A system, which optionally incorporates one or more features of any one or more of the preceding and/or following aspects, wherein the displayable information comprises displayable text.
12. A system, which optionally incorporates one or more features of any one or more of the preceding and/or following aspects, wherein the action comprises at least one of: making a phone call; displaying information; transmitting information; transmitting contact information; and making a purchase.
13. A system, which optionally incorporates one or more features of any one or more of the preceding and/or following aspects, wherein the augmented reality output comprises video that is displayed using the display screen.
14. A system, which optionally incorporates one or more features of any one or more of the preceding and/or following aspects, wherein the augmented reality output comprises audio that is played using the speaker.
15. An article, which optionally incorporates one or more features of any one or more of the preceding and/or following aspects, comprising: at least one QR code; at least one NFC tag; and at least one printed image; wherein the at least one QR code contains displayable information or contains a link to displayable information; wherein the at least one NFC tag is for causing a reading device to perform an action; and wherein the at least one printed image is for triggering an augmented reality output by the reading device.
16. A physical memory having instructions stored thereon, which are executable by a smart device, which optionally incorporates one or more features of any one or more of the preceding and/or following aspects, the instructions causing the smart device to; be enabled to read a QR code using a camera, and to display, using a display screen, displayable information that is contained in the QR code or that is linked via the QR code; be enabled to read an NFC tag, and to perform an action based on an NFC signal received from the NFC tag: and be enabled to recognize a printed image, and to provide an augmented reality output upon recognition of the printed image.
17. A method, which optionally incorporates one or more features of any one or more of the preceding and/or following aspects, comprising: placing at least one QR code on an article, the at least one QR code containing displayable information or a link to displayable information; placing at least one NFC tag on the article; and placing at least one printed image on the article.
18. A method, which optionally incorporates one or more features of any one or more of the preceding and/or following aspects, further comprising: enabling the reading device to read the at least one QR code using a camera, and to display the displayable information using a display screen.
19. A method, which optionally incorporates one or more features of any one or more of the preceding and/or following aspects, further comprising; enabling the reading device to read the at least one NFC tag.
20. A method, which optionally incorporates one or more features of any one or more of the preceding and/or following aspects, further comprising: configuring the reading device to perform an action based on an NFC signal received from the at least one NFC tag.
21. A method, which optionally incorporates one or more features of any one or more of the preceding and/or following aspects, further comprising: enabling the reading device to recognize the at least one printed image; and configuring the reading device to provide an augmented reality output when the at least one printed image is recognized.
22. A method, which optionally incorporates one or more features of any one or more of the preceding and/or following aspects, wherein the action comprises at least one of: making a purchase; making a payment; and automating an application such as sight or sound.

### BRIEF DESCRIPTION OF THE DRAWINGS

Further aspects and advantages of the invention will appear from the following description taken together with the accompanying drawings, in which:

FIG. 1 is a front view of a poster in accordance with an embodiment of the present invention;

FIG. 2 is a rear view of the poster shown in FIG. 1;

FIG. 3 is a front view of a smartphone used for interacting with the poster shown in FIG. 1; and

FIG. 4 is a rear view of the smartphone shown in FIG. 3.

### DETAILED DESCRIPTION OF THE DRAWINGS

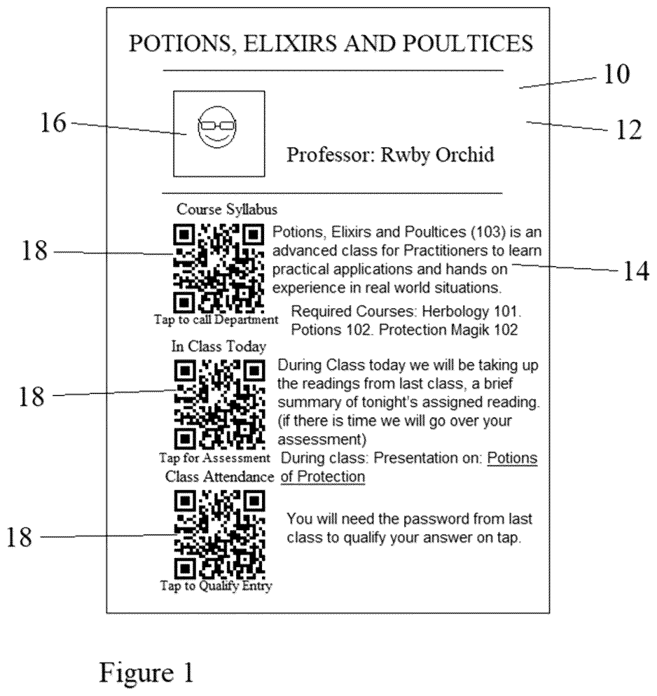

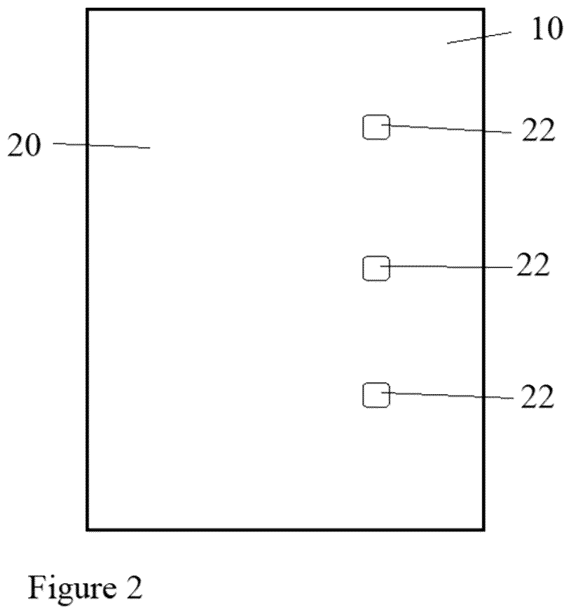

FIGS. 1 and 2 show a poster 10 in accordance with a preferred embodiment of the present invention. The poster 10 is formed from a thin sheet of material, such as paper. though any suitable material could be used. As shown in FIG. 1, the front side 12 of the poster 10 has printed text matter 14, a printed image 16, and three QR codes 18. As can be seen in FIG. 2, the back side 20 of the poster 10 has three NFC tags 22, which may for example be affixed to the poster 10 as stickers that are located behind each of the QR codes 18.

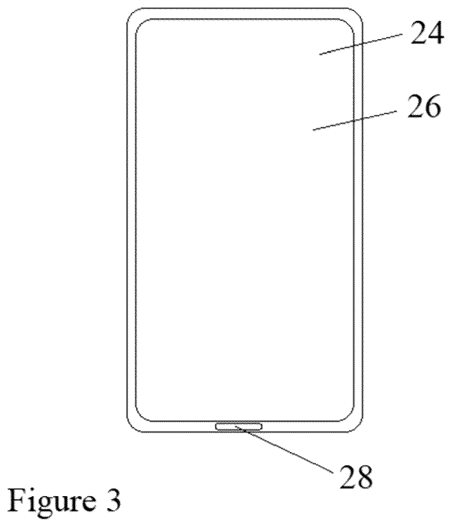

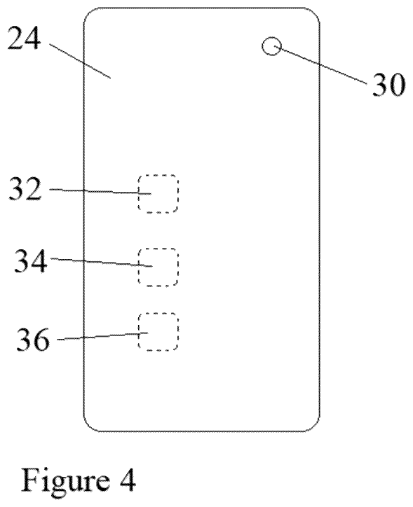

The poster 10 contains information that can be directly read by a person, such as the printed text 14, as well as information that requires a compatible reading device, such as the smartphone 24 shown in FIGS. 3 and 4. As can be seen in FIG. 3, the smartphone 24 has a display screen 26 for displaying images and videos, as well as a speaker 28 for playing audio. The smartphone 24 also has a camera 30, as shown in FIG. 4, as well as various internal components such as a processor 32, an NFC chip 34, and a memory 36, which are shown in dotted lines in FIG. 4.

Using the smartphone 24, a user can interact with the poster 10 to access additional information and features. Preferably, the smartphone 24 has an application which is stored in the memory 36, which enables the smartphone 24 to read and access all of the features of the poster 10. For example, the smartphone 24 is preferably enabled to read the QR codes 18 using the camera 30. The QR codes 18 may, for example, link to electronic documents via the application, which can be displayed on the display screen 26. Any suitable electronic document or file could be accessed via the QR codes 18, such as written text, images, videos, and/or audio files. In the example shown in FIG. 1, the QR codes 18 may link to documents such as a course syllabus and a class summary.

The smartphone 24 is also configured to recognize the printed image 16, and to provide an augmented reality output when the printed image 16 is recognized. In particular, the printed image 16 is preferably recognized by the application when the image 16 is viewed through the camera 30, which causes the application to produce the augmented reality output. The augmented reality output might, for example, be a video with accompanying audio which is played on the display screen 26 at the position where the image 16 is located when the poster 10 is viewed on the display screen 26. In the example shown in FIG. 1, the augmented reality output may, for example, be a video of a professor introducing himself and describing a course.

The smartphone 24 is further configured to read the NFC tags 22, and to perform predetermined actions when the NFC tags 22 are read. In particular, the application is preferably configured to recognize the NFC signals that are received from the NFC tags 22, and to instruct the smartphone 24 to perform one or more actions based on the NFC signals that are received. For example, the application may cause the smartphone 24 to call a particular telephone number when the first NFC tag 22 is tapped; to open a quiz or assessment when the second NFC tag is tapped; and to submit confirmation of attendance when the third NFC tag 22 is tapped.

The system in accordance with the invention thus allows a wide variety of different types of information to be communicated, as well as a wide variety of different interactions and features, using a single article that can be produced easily and at low cost.

It will be understood that, although various features of the invention have been described with respect to one or another of the embodiments of the invention, the various features and embodiments of the invention may be combined or used in conjunction with other features and embodiments of the invention as described and illustrated herein.

The invention is not limited to the exemplary embodiments that have been shown in the drawings. For example, the invention could be used with any type of article, and is not limited to a poster 10 as shown in the drawings. The invention could, for example, be incorporated into packaging, signage, a book, furniture, clothing, or any other suitable structure. When incorporated into a poster 10, the poster 10 could be formed from any suitable material or combination of materials, such as paper, plastic, cardboard, or particle board.

The article could include any desired number of QR codes 18, NFC tags 22, and printed images 16, and is not limited to the particular numbers of these shown in the examples. The QR codes 18, NFC tags 22, and printed images 16 could also be placed at any desired locations, and are not limited to the locations shown in the examples. For example, in some embodiments of the invention, the NFC tags 22 are located behind the QR codes 18. In other embodiments, the NFC tags 22 could be spaced from the QR codes 18. The location of the NFC tags 22 is preferably marked in some suitable manner on the poster 10, such as with a circle or a square or text labels.

In some embodiments of the invention, a color coded border may be used to inform an onlooker of the type of information being viewed. For example, the following color codes might be used: red=medical, orange=amber alert; yellow=environment; green financial; blue=business; indigo education; and violet=society/world news.

The NFC tags 22 may be used to trigger any desired action, including for example making a telephone call, opening a presentation or other document, or transmitting information such as contact information.

Any suitable images could be used to trigger the augmented reality output, including photographs, symbols, drawings, or text. The augmented reality output could take any suitable form, including video, audio, and/or computer generated graphics. In some embodiments of the invention, the augmented reality output could include a three dimensional model or object that is displayed on the display screen 26.

Although the exemplary embodiment has described the use of a smartphone 24 for interacting with the poster 10, any other suitable device could be used. For example, in some embodiments of the invention a tablet computer, an augmented reality headset, and/or a smart watch could be used. In some embodiments of the invention, the interactive features of the poster 10 may be different depending on the device that is used. For example, an NFC tag 22 may cause a student's phone 24 to perform a certain action (e.g. submitting attendance confirmation), and the same NFC tag 22 may cause the teacher's phone to perform a different action (e.g. check class attendance). This can be achieved through the application, which may be programed to perform different actions depending on the identity of the user.

In at least some preferred embodiments of the invention, one or more of the following advantages may be achieved: fully automated and unique user experience; cost effective; instant interaction and data collection; reduce light pollution; environmentally friendly; convey 8× more information than regular print ads; more information to the user; fast call to actions; instant data tracing; visually stunning; requires no screen or power source.

The invention can be useful in all sectors of society. In the case of medical uses, hospitals can use the invention to communicate useful information at a glance. Schools can use the invention for classes and for period check in and attendance. Shops can use the invention to get clients online check outs, product information or demonstration. Any other suitable applications could also be used.

Preferably, all pieces of the poster 10 are aligned prior to construction. In one preferred process, the components/steps are completed in the following order: picture 16, video, Augmented Reality coding, design print publication, attach NFC tags 22 and QR codes 18, and laminate the poster 10.

Although this disclosure has described and illustrated certain preferred embodiments of the invention, it is to be understood that the invention is not restricted to these particular embodiments. Rather, the invention includes all embodiments which are functional equivalents of the specific embodiments and features that have been described and illustrated herein.

We claim:

1. A system comprising:
an article having at least one QR code, at least one NFC tag, and at least one printed image; and
a device having a camera, an NFC chip, a display screen, and a speaker;
wherein the at least one QR code contains displayable information or contains a link to displayable information;
wherein the device is configured to read the at least one QR code using the camera, and to display the displayable information using the display screen;
wherein the device is configured to read the at least one NFC tag using the NFC chip, and to perform an action based on an NFC signal received from the at least one NFC tag;
wherein the device, using the camera, is configured to recognize the at least one printed image; and
wherein the device is configured to provide an augmented reality output upon recognition of the at least one printed image.

2. The system according to claim 1, wherein the article comprises a paper.

3. The system according to claim 1, wherein the article comprises a poster.

4. The system according to claim 1, wherein the device comprises a smartphone.

5. The system according to claim 1, wherein the device comprises a tablet computer.

6. The system according to claim 1, wherein the device comprises a smart watch.

7. The system according to claim 1, wherein the at least one QR code comprises a plurality of QR codes.

8. The system according to claim 1, wherein the at least one NFC tag comprises a plurality of NFC tags.

9. The system according to claim 1, wherein the at least one printed image comprises a plurality of printed images.

10. The system according to claim 1, wherein the article further comprises printed text.

11. The system according to claim 1, wherein the displayable information comprises displayable text.

12. The system according to claim 1, wherein the action comprises at least one of:
making a phone call;
displaying information;
transmitting information;
transmitting contact information; and
making a purchase.

13. The system according to claim 1, wherein the augmented reality output comprises video that is displayed using the display screen.

14. The system according to claim 1, wherein the augmented reality output comprises audio that is played using the speaker.

15. The system according to claim 1, wherein the article comprises at least one of: a paper and a poster; and
wherein the device comprises at least one of: a smartphone, a tablet computer, and a smart watch.

16. The system according to claim 15, wherein the at least one QR code comprises a plurality of QR codes;
wherein the at least one NFC tag comprises a plurality of NFC tags; and
wherein the at least one printed image comprises a plurality of printed images.

17. The system according to claim 16, wherein the article further comprises printed text.

18. The system according to claim 17, wherein the displayable information comprises displayable text.

19. The system according to claim 18, wherein the action comprises at least one of making a phone call;
displaying information;
transmitting information;
transmitting contact information; and
making a purchase.

20. The system according to claim 19, wherein the augmented reality output comprises at least one of:
video that is displayed using the display screen; and
audio that is played using the speaker.
